(19) United States
(12) Patent Application Publication
(10) Pub. No.: US 2025/0363801 A1
(43) Pub. Date: Nov. 27, 2025

(54) VIDEO PROCESSING METHOD, VIDEO PROCESSING DEVICE, AND STORAGE MEDIUM

(71) Applicant: Arashi Vision Inc., Shenzhen (CN)

(72) Inventors: Chunhong DENG, Shenzhen (CN); Yongjie HUANG, Shenzhen (CN); Junrong ZHU, Shenzhen (CN); Xiang LI, Shenzhen (CN)

(73) Assignee: Arashi Vision Inc., Shenzhen (CN)

(21) Appl. No.: 19/215,804

(22) Filed: May 22, 2025

(30) Foreign Application Priority Data
May 24, 2024 (CN) 2024106569043

(51) Int. Cl. G06V 20/17; B64C 39/02; G06V 20/40; H04N 5/783

(52) U.S. Cl. CPC G06V 20/17; B64C 39/024; G06V 20/49; H04N 5/783

(57) ABSTRACT

A video processing device may comprise at least one memory and at least one processor. The at least one memory may store executable instruction; and when executing the executable instruction stored in the at least one memory, the at least one processor may be configured to acquire video image data collected by an image acquirer of a flying object and a flight speed set of the flying object; determine at least one adjustment speed; determine a playback rate of the video image data based on the flight speed set and the at least one adjustment speed; and play the video image data at the playback rate.

### CROSS-REFERENCE TO RELATED APPLICATION

The present application claims priority to Chinese Patent Application No. 2024106569043, filed May 24, 2024, the entire contents of both being incorporated herein by reference in its entirety.

### TECHNICAL FIELD

The present application relates to a field of image processing technology, and in particular to a video processing method, device, equipment and storage medium.

### BACKGROUND

With rapid development of unmanned aerial vehicle (UAV) technology, UAVs have been widely used. At present, the main application of UAVs is to configure a camera device on the UAV and use the UAV for shooting.

### SUMMARY

In order to solve the above-mentioned or other technical problems, some embodiments of the present application provides a video processing method, device, and storage medium, which solves at least the problem of low fluency of video data collected by UAVs at present, and proposes an inventive video processing method for processing video data collected by UAVs, thereby ensuring the playback smoothness of video image data collected by UAVs and improving the playback quality of video image data collected by UAVs.

In one embodiment, the present application provides a video processing method. The video processing method may include acquiring video image data to be processed collected by an image acquirer of a flying object or structure and a flight speed set of the flying structure during a process of collecting the video image data to be processed; determining at least one adjustment speed, wherein the video image data to be processed, a flight speed in the flight speed set and the at least one adjustment speed have a corresponding relationship in time; determining a playback rate of the video image data to be processed based on the flight speed set and the at least one adjustment speed; and playing the video image data to be processed at the playback rate.

In another embodiment, the present application further provides a video process device. The video processing device may include circuitry configured to acquire video image data to be processed collected by an image acquirer of a flying structure and a flight speed set of the flying structure during a process of collecting the video image data to be processed; determine at least one adjustment speed, wherein the video image data to be processed, a flight speed in the flight speed set and the at least one adjustment speed have a corresponding relationship in time; determine a playback rate of the video image data to be processed based on the flight speed set and the at least one adjustment speed; and play the video image data to be processed at the playback rate.

In another embodiment, the present application further provides a video processing device, comprising: at least one memory and at least one processor, wherein the at least one memory stores executable instruction; and when executing the executable instruction stored in the at least one memory, the at least one processor is configured to acquire video image data to be processed collected by an image acquirer of a flying structure and a flight speed set of the flying structure during a process of collecting the video image data to be processed; determine at least one adjustment speed, wherein the video image data to be processed, a flight speed in the flight speed set and the at least one adjustment speed have a corresponding relationship in time; determine a playback rate of the video image data to be processed based on the flight speed set and the at least one adjustment speed; and play the video image data to be processed at the playback rate.

Some embodiments of the present application provide a video processing method, device, storage medium and a computer program product. After obtaining video image data to be processed collected by an image acquirer of a flying structure and a flight speed set of the flying structure during the process of collecting the video image data to be processed through a video processing device, at least one adjustment speed is determined, and based on the flight speed set and the at least one adjustment speed, a playback rate of the to-be-processed video image data is determined, and finally the to-be-processed video image data is played according to the playback rate, so as to achieve playback effect as of playing the video image data collected when the flying structure flies according to at least one adjustment speed. In this way, the playback rate is calculated and analyzed according to the determined at least one adjustment speed and the speed in the flight speed set of the flying structure, so as to play the to-be-processed video image data collected by the flying structure according to the playback rate, so that the playing of the video image data to be processed is smoother, which solves the problem of low fluency of the video data collected by the current UAVs, and proposes an inventive video processing method for processing the video data collected by the UAVs, which ensures the playback fluency of the video image data collected by the UAVs, and improves the playback quality of the video image data collected by the UAVs.

### BRIEF DESCRIPTION OF THE DRAWINGS

In order to more clearly illustrate the technical solutions in the embodiments of the present disclosure, the accompanying drawings to be used in the embodiments will be briefly introduced below, and it will be obvious that the accompanying drawings in the following description are only some of the embodiments of the present disclosure, and that for the person of ordinary skill in the field, other accompanying drawings can be obtained based on these drawings, without giving creative labor.

FIG. 1 is a schematic diagram of a flow chart of a video processing method in an embodiment of the present application;

FIG. 2 is a schematic diagram of a flight speed distribution in an embodiment of the present application;

FIG. 3 is a schematic diagram of an adjustment speed distribution determined in scenario one in an embodiment of the present application;

FIG. 4 is a schematic diagram of the adjustment speed distribution determined in scenario two in an embodiment of the present application;

FIG. 5 is a schematic diagram of the adjustment speed distribution determined in scenario three in an embodiment of the present application;

FIG. 6 is a schematic diagram of the adjustment speed distribution determined in scenario four in an embodiment of the present application;

FIG. 7 is a schematic diagram of the adjustment speed in scenario five provided in an embodiment of the present application;

FIG. 8 is a schematic diagram of the adjustment speed distribution determined in scenario five in an embodiment of the present application;

FIG. 9 is a schematic diagram of a flight speed distribution of in an embodiment of the present application;

FIG. 10 is a schematic diagram of a structure of a video processing device in an embodiment of the present application;

FIG. 11 is a schematic diagram of a structure of a video processing device in an embodiment of the present application.

### DETAILED DESCRIPTION

In order to make the purpose, technical solution and advantages of the present application more clearly understood, some embodiments of the present application are further described in detail below in conjunction with accompanying drawings and embodiments. It should be understood that the specific embodiments described herein are only used to explain the present application and are not used to limit the present application.

With rapid development of unmanned aerial vehicle (UAV) technology, UAVs have been widely used. At present, the main application of UAVs is to configure a camera device on the UAV and use the UAV for shooting.

During the shooting process, since the user remotely controls a flight of the UAV to shoot, smoothness of the camera movement is usually affected by flight conditions such as flight speed and turns of the UAV, thereby resulting in playing of the collected video image data being not smooth.

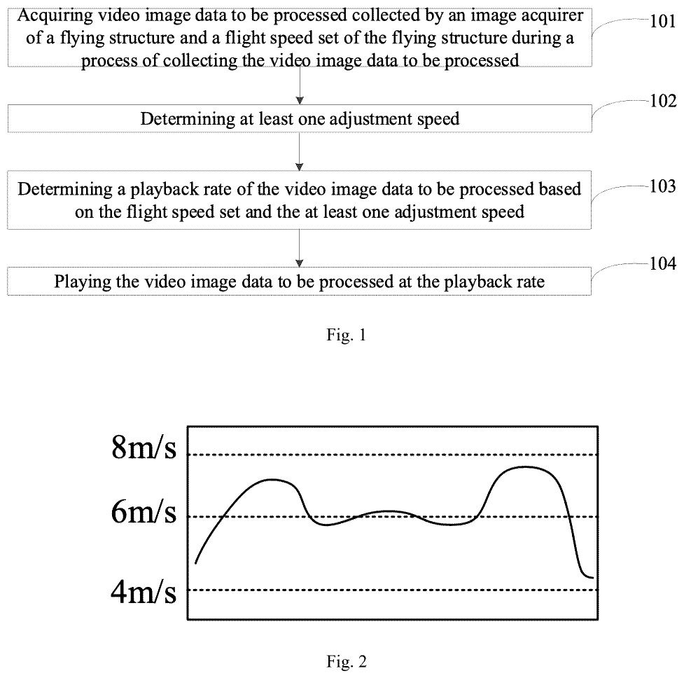

One embodiment of the present application provides a video processing method. As shown in FIG. 1, the method is applied to a video processing device. The method includes the following steps:

Step 101: acquiring video image data to be processed collected by an image acquisition device of a flying device and a flight speed set of the flying device during the process of collecting the video image data to be processed.

In one embodiment of the present application, the flying device may be a UAV. The image acquisition device may be a camera device or a lens module with an image acquisition function. In one embodiment, during flight, the flying device records an actual flight speed in real time according to a preset recording interval to obtain a flight speed set. The speed acquisition time in the flight speed set is consistent or identical with the time in the video image data to be processed.

An video processing device may be a device that can communicate with the flying device. It can communicate with the flying device through wired or wireless communication methods, realizing at least transmission of the video image data to be processed and the flight speed set collected by the flying device. When the video processing device and the flying device transmit data through wireless communication, the wireless communication method can be through Bluetooth, short-range wireless communication, or the Internet, etc.

In some embodiments, the video processing device can be integrated with the flying device, or it can be a terminal device independent of the flying device, for example, it can be a smart mobile terminal device, or various types of computer devices, etc.

In some embodiments, the video processing device can obtain the video image data to be processed from a smart head-mounted device that has a communication link with the flying device. After the flying device collects the images during flight, it sends the video image data to be processed to the smart head-mounted device, and then the smart head-mounted device sends the video image data to be processed to the video processing device via wired communication or wireless communication. The smart head-mounted device can be smart glasses, smart visualization helmets or other devices.

Step 102: determining at least one adjustment speed.

The video image data to be processed, the flight speed in the flight speed set, and at least one adjustment speed have a corresponding relationship in time.

In one embodiment of the present application, at least one adjustment speed corresponding to the video image data to be processed is determined based on relevant characteristic parameters corresponding to the video image data to be processed. The at least one adjustment speed is a desired flight speed corresponding to a flying device when collecting the video image data to be processed. In one embodiment, one adjustment speed can be adopted wholly for a section of video to be processed, that is, a video effect obtained by flying at a same flight speed. Of course, multiple adjustment speeds can be set for a section of video to be processed. For example, the video to be processed can be divided into multiple sub-video segments, and an adjustment speed is set for each sub-video segment.

The adjustment speed can be set manually or automatically. For example, it can be automatically set to a suitable adjustment speed according to a flight altitude or a camera or image acquirer movement mode. When the adjustment speed is manually set, there can be multiple interactive methods. For example, an operation button can be provided to a user to set the adjustment speed. The specific method for determining the adjustment speed is not limited here.

Step 103: determining a playback rate of the video image data to be processed based on the flight speed set and the at least one adjustment speed.

In one embodiment of the present application, the flight speed in the flight speed set and the corresponding speed in the at least one adjustment speed are analyzed to determine a playback rate of the video image data to be processed, wherein the playback rate of the video image data to be processed may be different in different playback time periods, that is, the playback rate may include one or more different rates according to distribution of the playback time. Optionally, a ratio of an actual flight speed at a moment to a corresponding adjustment speed at the moment may be used as the playback rate at the moment.

Step 104: playing the video image data to be processed at the playback rate.

The video image data to be processed is played at the playback rate to achieve a playback effect of playing the video image data collected when the flying device flies at at least one adjustment speed.

In one embodiment of the present application, when the video processing device plays the video image data to be processed, it can be played and displayed on a screen display area of the video processing device, or the playback rate and the video image data to be processed can be sent to a video playback device with a communication link therewith for playback and display.

The video image data to be processed is played and processed according to the determined playback rate, and the number of playback frames of the video image data to be processed within a corresponding time may be adjusted, so as to achieve an effect of playing the video image data to be processed as playing video data collected by the flying device flying at corresponding adjustment speeds in different time periods, thereby ensuring playback smoothness of the video image data to be processed, improving playback quality of the video image data to be processed, and further ensuring user experience.

The video processing method provided in some embodiments of the present application determines at least one adjustment speed after obtaining the video image data to be processed collected by the image acquisition device of the flying device and the flight speed set of the flying device during the process of collecting the video image data to be processed through the video processing device, and determines the playback rate of the video image data to be processed based on the flight speed set and the at least one adjustment speed, and finally plays the video image data to be processed at the playback rate, so as to achieve the playback effect as of playing the video image data collected when the flying device flies at the at least one adjustment speed. In this way, the playback rate is calculated and analyzed according to the speed in the determined at least one adjustment speed and the flight speed set of the flying device, so as to play the video image data to be processed collected by the flying device at the playback rate, so that the playing of the video image data to be processed is smoother, which solves the problem of low playback smoothness of the video data collected by current UAVs, and invents a video processing method for processing the video data collected by the UAV, which ensures playback smoothness of the video image data collected by the UAV, and improves playback quality of the video image data collected by the UAV.

Based on the foregoing embodiments, one embodiment of the present application provides a video processing method, which is applied to a video processing device. The method includes the following steps:

Step 201: acquiring video image data collected by an image acquisition device of a flying device and a flight speed set of the flying device during a process of collecting the video image data.

In an embodiment of the present application, a remote-controlled UAV equipped with a camera device is used as an example for explanation. During the flight of the UAV, the flight speed is remotely controlled by a user, and the camera device is always operational during the flight to shoot corresponding targets in a flight environment to obtain video image data. During the flight of the UAV, the flight speed is collected and recorded at a certain sampling interval to obtain a flight speed set.

Exemplarily, during a period from 13:00 to 13:30, a user controls a camera of a UAV to shoot a target, such as the ground, and obtains the corresponding video image data as well as a distribution of the flight speed of the UAV within this half an hour, and obtains the flight speed set. The UAV can send the collected video image data and the flight speed set to the video processing device, send them to the video processing device. For example, when actively sending, the UAV can immediately send the collected video image data and the flight speed set to the video processing device after detecting that the communication link between the UAV and the video processing device is established, so as to ensure that the UAV has enough storage space when the video processing device is detected; when passively sending, the video processing device can send a request for obtaining the video image data to be processed and the flight speed set to the UAV after the communication link between the UAV and the video processing device is established, and then the UAV responds to the request, and then sends the corresponding video image data to be processed and the flight speed set to the video processing device. In one embodiment, if the communication link between the UAV and the video processing device is established, the UAV sends the data. If the communication link between the UAV and the video processing device is not established, the UAV sends a request first.

Step 202: determining at least one adjustment speed.

The video image data the flight speed in the flight speed set, and at least one adjustment speed have a corresponding relationship in time.

In an embodiment of the present application, at least one adjustment speed may be calculated by a video processing device according to a preset algorithm based on flight characteristic parameters of the flying device, such as flight speed or flight altitude in the flight speed set, or may be set by a user based on experience requirements, or may be determined based on other requirements, such as operating parameters of the image acquisition device.

Step 203: determining a playback rate of the video image data to be processed based on the flight speed set and the at least one adjustment speed.

In an embodiment of the present application, the video processing device compares and analyzes the flight speed set and the at least one adjustment speed according to a preset empirical analysis method between the flight speed and the adjustment speed to determine the corresponding playback rate of the video image data

Step 204: playing the video image data to be processed at the playback rate.

The video image data is played at the playback rate to achieve a playback effect of playing the video image data collected when the flying device flies at at least one adjustment speed.

In an embodiment of the present application, when the video processing device has a screen display area, the video processing device can display the video image data played at the playback rate in the screen display area.

In some embodiments, steps 201 to 204 may be operations that are executed only when the video processing device detects a play instruction. In some application scenarios, in order to ensure the play efficiency, steps 201 to 203 may also be executed before the play instruction is detected. For example, the video processing device may be executed immediately after receiving the video image data to be processed, and the corresponding step 204 may be executed only after the play instruction is detected. The play instruction may be automatically generated by the video processing device itself according to the play demand, or may be generated by the user when there is a play demand.

Based on the above embodiments, in some embodiments of the present application, step 202 can be implemented by steps 202a-202b:

Step 202a: acquiring a flight altitude set of the flying device during the process of the image acquisition device acquiring the video image data to be processed.

In an embodiment of the present application, during the flight, the flying device collects video image data and also records its flight altitude parameters to obtain a flight altitude set. The flying device sends the collected flight altitude set to the video processing device.

Step 202b: determining at least one adjustment speed based on the flight altitude set.

In one embodiment of the present application, the video processing device analyzes the flight altitude parameter in the flight altitude set to determine the at least one adjustment speed. The adjustment speed corresponding to the flight altitude parameter can be calculated by an empirical calculation formula for the flight altitude parameter. The adjustment speed corresponding to the flight altitude parameter in the flight altitude set can also be found in an empirical table of flight altitudes and adjustment speeds, thereby obtaining the at least one adjustment speed.

Based on the foregoing embodiments, in some embodiments of the present application, step 202b can be implemented by the following steps: determine the flight speed corresponding to each flight altitude in the flight altitude set, and obtain at least one adjustment speed; wherein, there is a positive correlation between the flight altitudes and the speeds.

In an embodiment of the present application, the preset relationship between the flight altitudes and the speeds may be an empirical calculation formula or an empirical value table of different speed values corresponding to different altitudes, wherein in the preset relationship between the flight altitudes and the speeds, the relationship between the flight altitudes and the speeds is a positive correlation, that is, the higher the flight altitude, the greater the corresponding speed, i.e., the flight speed. In this way, the user can clearly perceive the changes in the photographed object when the flight device flies at a higher flight altitude, thereby ensuring the user's perceptual experience of viewing the video image data collected by the flying device.

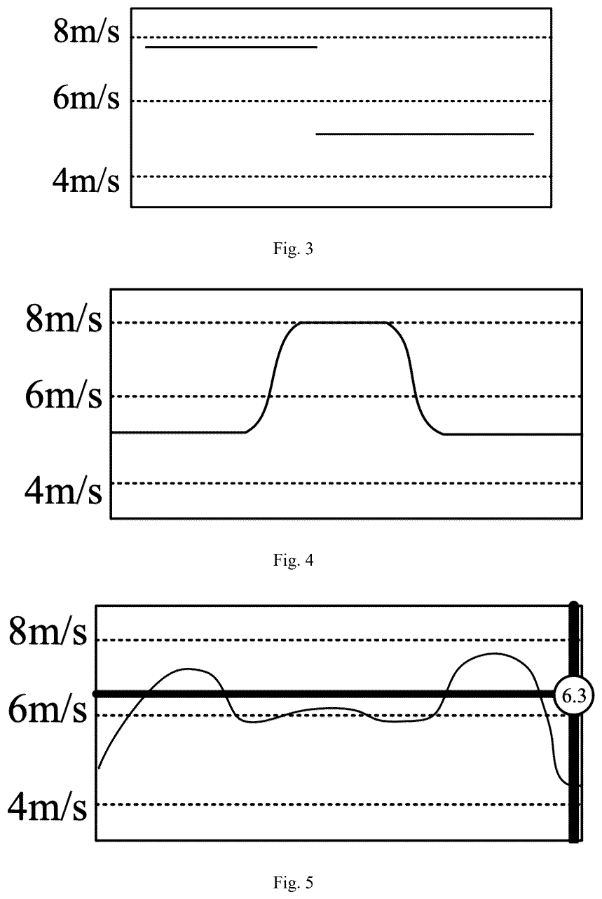

Exemplarily, according to the flight altitude, a preset flight speed at the corresponding altitude is wholly set. For example, when the flight altitude is 0-20 meters (m), the preset flight speed is 30 kilometers per hour (km/h), when the flight altitude is 20-50 m, the preset flight speed is 60 km/h, etc. Exemplarily, as shown in FIG. 2, a distribution curve of the flight speed in the flight speed set is shown, and correspondingly, a schematic diagram of two adjustment speed distribution determined according to the flight altitude in FIG. 2 can be shown in FIG. 3. In FIG. 2 and FIG. 3, the ordinate is the speed axis and the abscissa is the time axis.

In some application scenarios, for the distribution curve of the flight speed in the flight speed set shown in FIG. 2, when adjustment is needed, a virtual button of “one-key smoothing” (not shown in FIG. 2) can be set in FIG. 2. In this way, after the user touches the displayed virtual button of “one-key smoothing” according to actual needs, the video processing device calls the steps 202a˜202b to generate the adjustment speed shown in FIG. 3.

Based on the above embodiments, in some embodiments of the present application, step 202 can be implemented by steps 202c to 202d:

Step 202c: determining a corresponding image acquirer movement mode set in the process of the image acquirer when acquiring the video image data

In one embodiment of the present application, the image acquirer movement mode set of the image acquirer refers to movement actions of the image acquirer when the flying device carries the image acquirer, such as soaring, spiraling, washing pots, jumping off buildings, etc. The image acquirer movement modes in the image acquirer movement mode set are recorded according to time distribution, and the image acquirer movement modes in the image acquirer movement mode set can be repeated multiple times in different time periods, which can be determined by the actual application scenario of the image image acquirer of the flying device.

Step 202d: determining at least one adjustment speed based on the image acquirer movement mode set.

In an embodiment of the present application, corresponding adjustment speeds are pre-set for different image acquirer movement modes. The adjustment speed corresponding to each image acquirer movement mode may include more than one speed, which may be a certain speed distribution set distributed according to the image acquirer movement time.

Based on the foregoing embodiments, in some embodiments of the present application, step 202d further comprises: from a preset relationship between the image acquirer movement mode and the speed, determine at least one preset speed corresponding to each image acquirer movement mode in the image acquirer movement mode set, and obtain at least one adjustment speed.

In the embodiment of the present application, the relationship between the preset image acquirer movement mode and the speed can be a speed distribution calculation algorithm between the preset image acquirer movement modes and speeds in different image acquirer movement modes, or it can be an empirical speed value distribution, for example, it can be represented by a speed distribution curve. In this way, after determining the image acquirer movement mode set of the image acquirer, at least one corresponding preset speed can be obtained from the relationship between the preset image acquirer movement mode and the speed according to each image acquirer movement mode in the image acquirer movement mode set, and the at least one preset speed can be arranged according to the distribution of the image acquirer movement mode in the image acquirer movement mode set, so as to obtain at least one adjustment speed.

Exemplarily, based on the distribution curve of the flight speed in the flight speed set shown in FIG. 2, when it is identified that the image acquirer movement mode is skyward, the distribution pattern of the corresponding at least one preset speed is slow, fast, and slow, and the corresponding curve distribution can be shown in FIG. 4.

Based on the above embodiment, in some embodiments of the present application, step 202 may also be implemented by steps 202e to 202f:

Step 202e: detecting a touch operation in a touch area of the video processing device used to adjust the speed.

In one embodiment of the present application, the touch area may be an area where some physical buttons are located, that is, after the user controls these physical buttons to set the adjustment speed, a touch operation perceptible to the corresponding video processing device is generated. The touch area may also be a screen display area with a touch function of the video processing device. Correspondingly, the user may perform a touch operation on the touch area, so that the video processing device determines a touch track in the touch area and determines the touch operation on the adjustment speed setting. The user performs a touch operation in the touch area, which may be a touch operation on a virtual button displayed in the touch area, or a corresponding touch operation on the displayed image content.

Step 202f: determining at least one adjustment speed based on the touch operation.

In one embodiment of the present application, the video processing device analyzes the touch operation and determines at least one adjustment speed set by the user through the touch area.

Based on the above embodiment, in some embodiments of the present application, step 202e may further comprise steps a11-a12:

Step a11: displaying a virtual button for setting the adjustment speed in the display area corresponding to the video processing device.

In an embodiment of the present application, the display area corresponding to the video processing device may be a screen display area of the video processing device, which displays a distribution curve of the flight speed set over time and also displays a virtual button for setting the adjustment speed.

Step a12: detecting a touch pressing trajectory of a touch object on the virtual button in the touch area to obtain the touch operation.

In one embodiment of the present application, the touch object may be an object that performs a touch operation on the touch area, such as a stylus, a user's finger, etc. The touch area and the display area may be the same area or may not be the same area, depending on the actual configuration of the video processing device.

Exemplarily, the user can touch the virtual button in the figure and drag the virtual button along a horizontal direction at a desired adjustment speed to form a continuous operation trajectory. Alternatively, as shown in FIG. 5, during display of the speed value curve of the flight speed set, the adjustment speed distribution can be obtained by adjusting a position of a virtual button on an adjustment speed distribution progress bar set on the right, specifically the bold solid line in FIG. 5, thereby setting the virtual button on the adjustment speed distribution progress bar to a position of 6.3, and setting the adjustment speed to 6.3 m/s. In this way, the operation trajectory is detected and identified to obtain the touch operation.

Based on the above embodiment, in some embodiments of the present application, step 202e may further comprise steps b11-b12:

Step b11: displaying the flight speed curve of the flying device corresponding to the flight speed set in the display area corresponding to the video processing device.

In an embodiment of the present application, the video processing device draws a flight speed curve distributed over time according to the flight speed of the flight speed set, and displays the drawn flight speed curve.

Step b12: detecting a touch operation of the touch object selecting a point on the flight speed curve in the touch area.

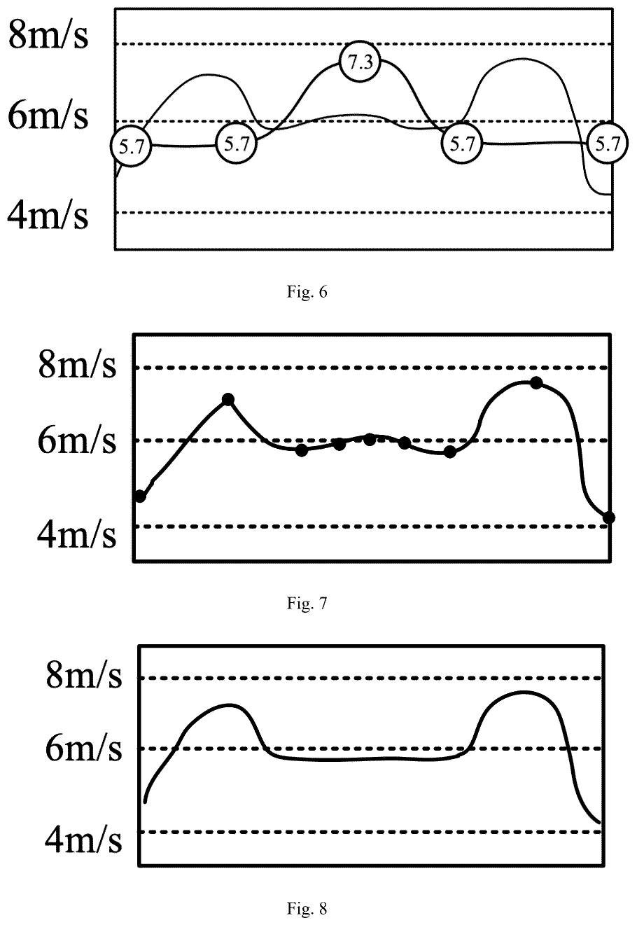

In the embodiment of the present application, after the flight speed curve is displayed, the user can make a touch selection in the touch area. According to the distribution of the flight speed curve, the user selects some independent touch points, and displays the touch points with graphic marks. Finally, these touch points are connected with a smooth curve in the order of flight time to obtain a touch operation, so as to determine at least one adjustment speed. Exemplarily, as shown in FIG. 6, the user can make a touch selection at different positions according to the distribution curve of the flight speed set displayed in the display area to obtain multiple selection points, and set a selection graphic mark in the form of a virtual button at the selection point for intuitive display to prompt the user of the selected point. Finally, the multiple virtual buttons are connected with a smooth curve in the order of flight time to obtain at least one adjustment speed corresponding to the touch operation. The thin solid line in FIG. 6 is the flight speed distribution in the flight speed set, and the button on the thick solid line also displays the speed corresponding to the selected point. The thick solid line is the final corresponding at least one adjustment speed distribution. Alternatively, as shown in FIG. 7, the user may select break selection speeds at a plurality of selected points on the displayed distribution curve according to the flight speed distribution curve of the flight speed set displayed in the display area, and then optimize the speed according to the plurality of selected points to obtain the adjusted speed distribution as shown in FIG. 8.

Based on the above embodiments, in some embodiments of the present application, step 203 may further comprise steps 203a-203b:

Step 203a: based on the flight speed set, determining an analysis speed corresponding to each moment.

In one embodiment of the present application, the flight speed included in the flight speed set is analyzed to determine an analysis speed corresponding to each moment included in the flight speed set. The analysis speed may be a flight speed included in the flight speed set, or may be determined by calculating and analyzing multiple flight speeds in the flight speed set. When determining the analysis speed corresponding to each moment, the speed in the flight speed set may be segmented in a segmented manner, and the flight speed within each time range may be analyzed to determine the analysis speed corresponding to each moment.

Step 203b: determining a playback rate corresponding to each moment based on the analysis speed corresponding to each moment and an adjustment speed of at least one adjustment speed corresponding to the moment.

In an embodiment of the present application, when playing the video image data, the analysis speed corresponding to each moment and the adjustment speed corresponding to the moment among the at least one adjustment speed are analyzed to determine the playback rate corresponding to each moment.

Correspondingly, step 204 can be implemented by the following steps: playing the video image data according to the corresponding playing rate at each moment.

In one embodiment of the present application, after determining the playback rate corresponding to each moment, the video processing device plays the video image data to be processed according to the determined playback rate corresponding to each moment.

Based on the above embodiment, in some embodiments of the present application, step 203a can be implemented by steps c11 to c13:

Step c11: segmenting the video image data to obtain m segments of sub-video image data.

Here, m is a positive integer greater than or equal to 1.

In one embodiment of the present application, the video image data to be processed is segmented according to a preset segmentation rule to obtain m segments of sub-video image data, where m is determined by the actual segmentation situation and its minimum value is 1.

Step c12: from the flight speed set, obtaining a flight speed subset corresponding to each sub-video image data.

In one embodiment of the present application, according to the corresponding time distribution of each sub-video image data, the speed in the flight speed set is also segmented to obtain corresponding m flight speed subsets.

Step c13: based on each flight speed subset, determining an analysis speed corresponding to each moment.

In an embodiment of the present application, the video processing device analyzes the speed in each flight speed subset and determines the analysis speed distribution within the time period corresponding to each sub-video image data, so that the analysis speed corresponding to each moment can be obtained.

Based on the foregoing embodiment, in some embodiments of the present application, step c11 may further comprise c111 or step c112:

Step c111: segmenting the video image data to be processed according to a preset segment duration to obtain m segments of sub-video image data.

In one embodiment of the present application, the preset segmentation duration is an empirical duration obtained from a large number of experiments, or an empirical duration set by the user based on his own experience. In the actual application process, it can be continuously corrected according to actual needs. For example, assuming that the preset segmentation duration is s seconds, the video image data to be processed is segmented at intervals of s seconds from the beginning, thereby obtaining m segments of sub-video image data.

Step c112: according to a segmentation rule that fluctuation range of the flight speed in a continuous time period is within a preset threshold range, the video image data to be processed is segmented to obtain m segments of sub-video image data.

In one embodiment of the present application, the preset threshold value can be an empirical value of the flight speed deviation obtained from a large number of experiments, and can be set according to actual needs in the actual application process. Exemplarily, taking flight speed u1 corresponding to the 0th second of the video image data to be processed as a reference, determine whether the flight speed in the continuous time period starting from the 0th second is within the range of u1±Δ, and when it is detected that the flight speed at the jth second exceeds the u1Δ range, the video image data to be processed is segmented at the j-1th second to obtain the first segment of sub-video image data with a duration range of the 0th second to the j-1th second. Then, taking the flight speed u2 at the jth second as a reference, determine that the flight speed at the kth second of the subsequent continuous time period exceeds the u2+Δ range, and segment the video image data at the k-1th second to obtain the second segment of sub-video image data with a duration range of the jth second to the k-1th second, and repeat until the segmentation reaches the last second of the video image data to be processed. In this process, the duration of each segment of sub-video image data may be unequal.

Based on the above embodiment, in some embodiments of the present application, step 203b can be implemented by steps d11 to d12:

Step d11, calculating a ratio of the corresponding adjustment speed to the corresponding analysis speed at each moment.

In the embodiment of the present application, assuming that the adjustment speed corresponding to the i-th moment is uₘᵢ, and the analysis speed corresponding to the i-th moment obtained by corresponding analysis is u_{fi}, then the ratio Bi corresponding to the i-th moment can be calculated using the following calculation formula: Bi=uₘᵢ/u_{fi}.

Step d12: determining the corresponding playback rate based on the corresponding ratio at each moment.

In the embodiment of the present application, the playback rate of the video image data at the corresponding moment is adjusted according to the ratio corresponding to each sub-video image data to obtain the corresponding playback rate.

Exemplarily, after the video image data is segmented to obtain m segments of sub-video image data, the adjustment speed corresponding to each sub-video image data is determined from at least one adjustment speed to obtain the target speed, and then the playback rate corresponding to each sub-video image data is determined based on each flight speed subset and the corresponding target speed, wherein the playback rate includes m groups of sub-playback rates.

Among them, for at least one adjustment speed, according to the time distribution corresponding to each sub-video image data, the at least one adjustment speed is also segmented according to the time distribution to obtain the target speeds corresponding to the m sub-video image data, and the i-th flight speed subset and the corresponding i-th target speed are analyzed to determine the sub-playback rate corresponding to the i-th sub-video image data, wherein the value of i is 1, 2, . . . , m.

Correspondingly, the corresponding sub-video image data can be played at the sub-playing rate of each sub-video image data, thereby realizing the process of playing the video image data to be processed at the corresponding playing rate at each moment.

Based on the above embodiments, in some embodiments of the present application, step c13 can be implemented by step c131 or steps c132-c133:

Step c131: determining the nth flight speed from each flight speed subset as the analysis speed.

Wherein, n is less than or equal to the total number of elements included in each flight speed subset.

In one embodiment of the present application, n is an empirical value, which can be determined based on the total number included in each flight speed subset, or can be a directly specified empirical value, for example, it can be the flight speed corresponding to the second in the sub-video image data corresponding to each flight speed subset. Exemplarily, the first flight speed in each flight speed subset may be determined as the analysis speed of the corresponding sub-video image data. In some application scenarios, the speed with the highest frequency in each flight speed subset can also be determined as the analysis speed.

Step c132, calculating a speed average of the flight speeds included in each flight speed subset.

In one embodiment of the present application, an average value calculation method or a weighted average value calculation method is used to calculate the speed average value of each flight speed subset.

Step c133, determining the speed average as the analysis speed.

In one embodiment of the present application, the analysis speed of the sub-video image data corresponding to each flight speed subset is determined as the calculated speed average value.

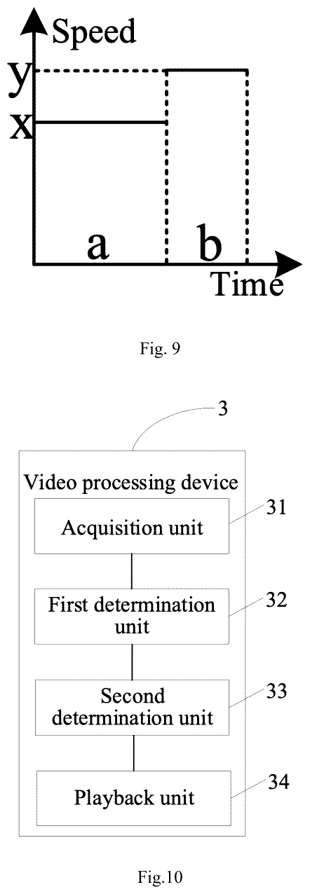

Exemplarily, as shown in FIG. 9, the video image data can be divided into two segments according to time, one segment with a duration a and the other with a duration b. The analysis speed of the sub-video image data in time period a is determined to be xm/s, and the analysis speed corresponding to the sub-video image data in time period b is determined to be ym/s. Assuming that the determined adjustment speed is zm/s, it can be determined that the video playback rate corresponding to the sub-video image data in time period a is (z/x)*P frames/s, and the video playback rate corresponding to the sub-video image data in time period b is (z/y)*P frames/s, wherein P frames/s is the playback rate of the video image data to be processed when it is played at a normal 1× speed.

Based on the foregoing embodiment, in some embodiments of the present application, step d12 may be implemented by step d121 or step d122:

Step d121: if the ratio corresponding to each moment is greater than 1, performing frame skipping playback processing on the image frame data at the corresponding moment according to the ratio to obtain a playback rate corresponding to the ratio.

In one embodiment of the present application, when the ratio is greater than 1, the corresponding video image data frames are subjected to frame skipping playback processing according to the ratio, thereby speeding up the playback rate of the video image data at that moment and obtaining the playback rate corresponding to the ratio.

Step d122: if the ratio corresponding to each moment is less than 1, the image frame data at the corresponding moment is processed for frame supplementation according to the ratio to obtain a playback rate corresponding to the ratio.

In one embodiment of the present application, when the ratio is less than 1, the video image data at the corresponding moment is processed for frame supplementation according to the ratio, and the playback rate of the video image data at that moment is lowered.

In this way, a variable speed playback mode for aerial video is realized, which ensures smoothness of the aerial video playback process and improves playback quality of the video image.

It should be noted that, for the description of the same steps and the same contents in this embodiment as those in other embodiments, reference can be made to the description in other embodiments and will not be repeated here.

The video processing method provided in some embodiments of the present application determines at least one adjustment speed after obtaining the video image data collected by the image acquisition device of the flying device and the flight speed set of the flying device during the process of collecting the video image data and determines the playback rate of the video image data to be processed based on the flight speed set and the at least one adjustment speed, and finally plays the video image data at the playback rate, so as to achieve the playback effect as of playing the video image data collected when the flying device flies at the at least one adjustment speed. In this way, the playback rate is calculated and analyzed according to the speed in the determined at least one adjustment speed and the flight speed set of the flying device, so as to play the video image data to be processed collected by the flying device at the playback rate, so that playing of the video image data to be processed is smoother, which solves the problem of low playback fluency of the video data collected by the current UAV, and invents a video processing method for processing the video data collected by the UAV, which ensures the playback fluency of the video image data collected by the UAV, and improves the playback quality of the video image data collected by the UAV.

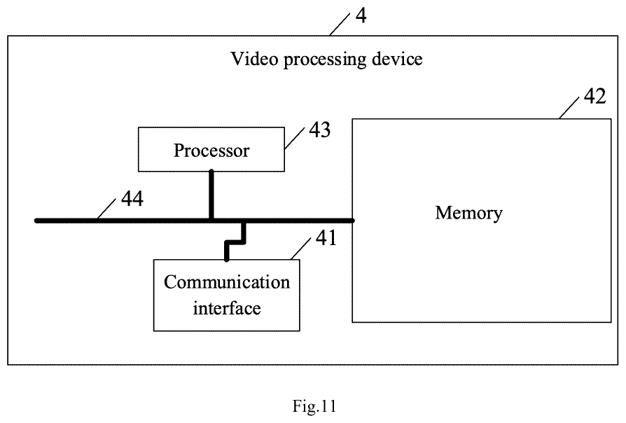

Based on the foregoing embodiments, an embodiment of the present application provides a video processing device, which can be applied to the video processing method provided in FIG. 1 and the foregoing method embodiments. As shown in FIG. 10, the video processing device 3 may include: an acquisition unit 31, a first determination unit 32, a second determination unit 33 and a playback unit 34.

In one embodiment, the acquisition unit 31 is configured to acquire the video image data acquired by the image acquisition device of a flying device and a flight speed set of the flying device during the process of acquiring the video image data to be processed;
the first determining unit 32 is configured to determine at least one adjustment speed; wherein the video image data, the flight speed in the flight speed set and the at least one adjustment speed have a corresponding relationship in time;
the second determining unit 33 is configured to determine a playback rate of the video image data based on the flight speed set and the at least one adjustment speed; and
the playback unit 34 is configured to play the video image data at the playback rate to achieve a playback effect as of playing the video image data collected when the flying device flies at the at least one adjusted speed.

In some embodiments of the present application, the first determination unit includes: a first acquisition module and a first determination module.

The first acquisition module is configured to acquire a flight altitude set of the flying device during the process of the image acquisition device acquiring the video image data.

The first determination module is configured to determine the at least one adjustment speed based on the flight altitude set.

In some embodiments of the present application, the first determining module is specifically configured to implement the following steps:
from a preset relationship between the flight altitudes and the speeds, determining the speed corresponding to each flight altitude in the flight altitude set to obtain at least one adjustment speed; wherein, in the preset relationship between the flight altitudes and the speeds, the flight altitude and the speed are positively correlated.

In some embodiments of the present application, the first determination unit includes a second determination module and a third determination module.

The second determination module is configured to determine a corresponding camera movement mode set during a process in which the image acquisition device acquires the video image data to be processed;

The third determination module is configured to determine at least one adjustment speed based on the camera movement mode set.

In some embodiments of the present application, the third determination module is specifically configured to implement the following steps:

Determining at least one preset speed corresponding to each camera movement mode in the camera movement mode set from the relationship between the preset camera movement modes and the speeds, and obtaining at least one adjustment speed.

In some embodiments of the present application, the first determination unit includes: a detection module and a fourth determination module.

The detection module is configured to detect a touch operation of a touch area used by a video processing device to determine a adjustment speed.

The fourth determination module is configured to determine at least one adjustment speed based on the touch operation.

In some embodiments of the present application, the detection module further comprise the following steps:
in the display area corresponding to the video processing device, displaying a virtual button for setting the adjustment speed; and
detecting the touch pressing track of the touch object on the virtual button in the touch area to obtain the touch operation.

In some embodiments of the present application, the detection module can be implemented by the following steps:
in the display area corresponding to the video processing device, displaying a flight speed curve of the flying device corresponding to the flight speed set; and
in the touch area, detecting a touch operation of the touch object selecting a point on the flight speed curve.

In some embodiments of the present application, the second determination unit includes: a fifth determination module and a sixth determination module.

The fifth determination module is configured to determine an analysis speed corresponding to each moment based on the flight speed set.

The sixth determination module is configured to determine a playback rate corresponding to each moment based on the analysis speed corresponding to each moment and an adjustment speed corresponding to the moment in at least one of the adjustment speeds.

Correspondingly, the playback unit is configured to implement the following steps:
playing the video image data to be processed at the corresponding playing rate at each moment.

In some embodiments of the present application, the fifth determination module is specifically configured to implement the following steps:
segmenting the video image data to be processed to obtain m segments of sub-video image data; wherein m is a positive integer greater than or equal to 1;
from the flight speed set, obtaining a flight speed subset corresponding to each sub-video image data;
based on each of the flight speed subsets, determining the analysis speed corresponding to each moment.

In some embodiments of the present application, the processing module is specifically configured to implement the following steps:
segmenting the video image data to be processed according to a preset segment duration to obtain m segments of sub-video image data.

Alternatively, according to the segmentation rule that a fluctuation range of the flight speed in a continuous time period is within a preset threshold range, the video image data to be processed is segmented to obtain m segments of sub-video image data.

In some embodiments of the present application, the sixth determination module is specifically configured to implement the following steps:
calculating a ratio of the adjustment speed corresponding to each moment to the corresponding analysis speed; and
determining the corresponding playback rate based on the corresponding ratio at each moment.

In some embodiments of the present application, the fifth determination module is configured to implement the step of determining the analysis speed corresponding to each moment based on each flight speed subset, which can be implemented by the following steps:
from each flight speed subset, determining the nth flight speed as the analysis speed; wherein n is less than or equal to the total number of elements included in each flight speed subset;
alternatively, calculating a speed average of the flight speeds included in each flight speed subset; and
determining the speed average as the analysis speed.

In some embodiments of the present application, when the sixth determination module is configured to implement the step of determining the corresponding playback rate based on the ratio corresponding to each moment, it can be implemented by the following steps:
if the ratio corresponding to each moment is greater than 1, subjecting the image frame data at the corresponding moment to frame skipping playback processing according to the ratio to obtain the playback rate corresponding to the ratio; and
if the ratio corresponding to each moment is less than 1, subjecting the image frame data at the corresponding moment to frame supplementation and playback processing according to the ratio to obtain the playback rate corresponding to the ratio.

It should be noted that the specific implementation process of the interaction between the units and the modules in the embodiments of the present application can refer to the implementation process in the video processing method provided in the aforementioned embodiments, and will not be repeated here.

The video processing device provided in some embodiments of the present application determines at least one adjustment speed after obtaining the video image data to be processed collected by the image acquisition device of the flying device and the flight speed set of the flying device during the process of collecting the video image data to be processed through the video processing device, and determines the playback rate of the video image data to be processed based on the flight speed set and the at least one adjustment speed, and finally plays the video image data to be processed at the playback rate, so as to achieve the playback effect as of playing the video image data collected when the flying device flies at at least one adjustment speed. In this way, the playback rate is obtained by calculating and analyzing the speed in the determined at least one adjustment speed and the flight speed set of the flying device, so as to play the video image data to be processed collected by the flying device at the playback rate, so that the playing of the video image data to be processed is smoother, which solves the problem of low playback fluency of the video data collected by the current UAV, and invents a video processing method for processing the video data collected by the UAV, which ensures the playback fluency of the video image data collected by the UAV, and improves the playback quality of the video image data collected by the UAV.

Based on the above embodiments, some embodiments of the present application provide a video processing device, which can be applied to the video processing method provided in FIG. 1 and the above corresponding embodiments. As shown in FIG. 11, the video processing device 4 may include: a communication interface 41, a memory 42, a processor 43 and a communication bus 44.

The memory 42 is configured to store executable instructions.

The communication bus 44 is configured to realize the communication connection between the communication interface 41, the processor 43 and the memory 42.

The processor 43 is configured to execute the video processing method stored in the memory 42, and is configured to implement the implementation process of the video processing method provided in FIG. 1 and the aforementioned corresponding embodiments, which will not be described in detail here.

Based on the aforementioned embodiments, an embodiment of the present application provides a computer-readable storage medium, referred to as a storage medium for short, which stores one or more programs, and the one or more programs can be executed by one or more processors to implement the implementation process in the video processing method provided with reference to FIG. 1 and the aforementioned corresponding embodiments, which will not be repeated here.

Based on the foregoing embodiments, an embodiment of the present application further provides a computer program product, including a computer program, which can be executed by the processor 43 of the video processing device 4 to complete any of the foregoing method steps.

Those skilled in the art will appreciate that the embodiments of the present application may be provided as methods, systems, or computer program products. Therefore, the present application may take the form of hardware embodiments, software embodiments, or embodiments combining software and hardware. Moreover, the present application may take the form of a computer program product implemented on one or more computer-usable storage media (including but not limited to disk storage and optical storage, etc.) containing computer-usable program codes.

The present application is described with reference to the flowchart and/or block diagram of the method, device (system), and computer program product according to the embodiment of the present application. It should be understood that each process and/or box in the flowchart and/or block diagram, as well as the combination of the process and/or box in the flowchart and/or block diagram can be implemented by computer program instructions. These computer program instructions can be provided to a processor of a general-purpose computer, a special-purpose computer, an embedded processor, circuitry, or other programmable data processing device to generate a machine, so that the instructions executed by the processor of the computer, the circuitry or other programmable data processing device generate a device for implementing the functions specified in one process or multiple processes in the flowchart and/or one box or multiple boxes in the block diagram.

These computer program instructions may also be stored in a computer-readable memory that can direct a computer or other programmable data processing device to operate in a specific manner, so that the instructions stored in the computer-readable memory produce a manufactured product including an instruction device that implements the functions specified in one or more processes in the flowchart and/or one or more boxes in the block diagram.

These computer program instructions may also be loaded onto a computer or other programmable data processing device so that a series of operational steps are executed on the computer or other programmable device to produce a computer-implemented process, whereby the instructions executed on the computer or other programmable device provide steps for implementing the functions specified in one or more processes in the flowchart and/or one or more boxes in the block diagram.

The above-described embodiments only express several implementation methods of the present application, and the descriptions thereof are relatively specific and detailed, but they cannot be understood as limiting the scope of the present application. It should be pointed out that, for a person of ordinary skill in the art, several variations and improvements can be made without departing from the concept of the present application, and these all belong to the protection scope of the present application. Therefore, the protection scope of the present application shall be subject to the attached claims.

What is claimed is:

1. A video processing device, comprising: at least one memory and at least one processor, wherein:
the at least one memory stores executable instruction; and
when executing the executable instruction stored in the at least one memory, the at least one processor is configured to:
acquire video image data collected by an image acquirer of a flying object and a flight speed set of the flying object;
determine at least one adjustment speed;
determine a playback rate of the video image data based on the flight speed set and the at least one adjustment speed; and
play the video image data at the playback rate.

2. The video processing device according to claim 1, wherein the determining at least one adjustment speed comprises:
acquiring a flight altitude set of the flying object; and
determining the at least one adjustment speed based on the flying altitude set,
wherein the video image data, a flight speed in the flight speed set and the at least one adjustment speed have a corresponding relationship in time.

3. The video processing device according to claim 2, wherein the determining the at least one adjustment speed based on the flight altitude set comprises:
determining a speed corresponding to each flight altitude in the flight altitude set to obtain the at least one adjustment speed according to a preset relationship between flight altitudes and speeds,
wherein in the preset relationship between flight altitudes and speeds, the flight altitudes are positively correlated with the speeds.

4. The video processing device according to claim 1, wherein the determining at least one adjustment speed comprises:
determining an image acquirer movement mode set when the image acquirer acquires the video image data; and
determining the at least one adjustment speed based on the image acquirer movement mode set.

5. The video processing device according to claim 4, wherein the determining the at least one adjustment speed based on the image acquirer movement mode set comprises:
determining at least one preset speed corresponding to each image acquirer movement mode in the image acquirer movement mode set according to a relationship between preset image acquirer movement modes and speeds, and
obtaining the at least one adjustment speed based on the at least one preset speed.

6. The video processing device according to claim 1, wherein the determining at least one adjustment speed comprises:
detecting a user operation to adjust the adjustment speed; and
determining the at least one adjustment speed based on the user operation.

7. The video processing device according to claim 6, wherein the detecting the user operation to adjust the adjustment speed comprises:
displaying a virtual button for setting the adjustment speed in a display area corresponding to the video processor; and
detecting a touch pressing track of a touch object on the virtual button.

8. The video processing device according to claim 6, wherein the detecting the user operation to adjust the adjustment speed comprises:
displaying, in a display area corresponding to the video processing device, a flight speed curve of the flying object corresponding to the flight speed set; and
detecting a touch operation by selecting a point on the flight speed curve in the touch area.

9. The video processing device according to claim 1, wherein the determining the playback rate of the video image data based on the flight speed set and the at least one adjustment speed comprises:
determining an analysis speed corresponding to each moment based on the flight speed set; and
determining a playback rate corresponding to each moment based on the analysis speed corresponding to each moment and an adjustment speed corresponding to the moment among the at least one adjustment speed.

10. The video processing device according to claim 9, wherein the playing the video image data at the playing rate comprises:
playing the video image data at the playing rate corresponding to each moment.

11. The video processing device according to claim 9, wherein the determining the analysis speed corresponding to each moment based on the flight speed set comprises:
segmenting the video image data to obtain one or more segments of sub-video image data;
obtaining a flight speed subset corresponding to each sub-video image data from the flight speed set; and
determining the analysis speed corresponding to each moment based on each of the flight speed subsets.

12. The video processing device according to claim 11, wherein the segmenting the video image data to obtain the one or more segments of sub-video image data comprises:
segmenting the video image data according to a preset segment duration to obtain the one or more segments of sub-video image data; or
segmenting the video image data according to a segmentation rule that a fluctuation range of the flight speed in a continuous time period is within a preset threshold range to obtain the one or more segments of the sub-video image data.

13. The video processing device according to claim 12, wherein the determining the playback rate corresponding to each moment based on the analysis speed corresponding to each moment and the adjustment speed corresponding to the moment among the at least one adjustment speed comprises:
calculating a ratio of the adjustment speed corresponding to each moment to the analysis speed corresponding to the moment; and
determining the playback rate corresponding to each moment based on the ratio corresponding to each moment.

14. The video processing device according to claim 11, wherein the determining the analysis speed corresponding to each moment based on each of the flight speed subsets comprises:
determining a nth flight speed from each of the flight speed subsets as the analysis speed, wherein n is less than or equal to a total number of elements included in each of the flight speed subsets; or
calculating a speed average of the flight speeds included in each of the flight speed subsets and determining the speed average as the analysis speed.

15. The video processing device according to claim 13, wherein the determining the corresponding playback rate based on the ratio corresponding to each moment comprises:
if the ratio corresponding to each moment is greater than 1, subjecting the image frame data at the corresponding moment to frame skipping playback processing according to the ratio to obtain the playback rate corresponding to the ratio; and
if the ratio corresponding to each moment is less than 1, subjecting the image frame data at the corresponding moment to frame supplementation according to the ratio to obtain the playback rate corresponding to the ratio.

16. The video processing device according to claim 1, wherein the video processing device is at least partially integrated onto the flying object or the video processing device is a terminal independent from the flying object.

17. The video processing device according to claim 1, wherein the flying object is an unmanned aerial vehicle, and the image acquirer is a camera or a lens module with an image acquisition function.

18. An unmanned aerial vehicle, comprising the video processing device according to claim 1.
